(19) United States
(12) Patent Application Publication
(10) Pub. No.: US 2025/0392961 A1
(43) Pub. Date: Dec. 25, 2025

(54) WIRELESS COMMUNICATION METHOD, COMMUNICATIONS DEVICE, AND TERMINAL DEVICE

(71) Applicant: QUECTEL WIRELESS SOLUTIONS CO., LTD., Shanghai (CN)

(72) Inventor: Qufang HUANG, Shanghai (CN)

(21) Appl. No.: 19/313,771

(22) Filed: Aug. 28, 2025

Related U.S. Application Data
(63) Continuation of application No. PCT/CN2024/071657, filed on Jan. 10, 2024.

(51) Int. Cl. H04W 28/10; H04L 67/133; H04W 28/16; H04W 72/232

(52) U.S. Cl. CPC H04W 28/10; H04L 67/133; H04W 28/16; H04W 72/232

(57) ABSTRACT

The present application provides a wireless communication method, a communications device, and a terminal device. One example method includes: obtaining multimodal relationship information, wherein the multimodal relationship information indicates a multimodal relationship between a plurality of data flows, and the plurality of data flows belong to a plurality of terminal devices; and scheduling the plurality of data flows of the plurality of terminal devices based on the multimodal relationship information.

### CROSS-REFERENCE TO RELATED APPLICATIONS

This application is a continuation of International Application No. PCT/CN2024/071657, filed on Jan. 10, 2024, the disclosure of which is hereby incorporated by reference in its entirety.

### TECHNICAL FIELD

The present application relates to the field of communications technologies, and more specifically, to a wireless communication method, a communications device, and a terminal device.

### BACKGROUND

A plurality of data flows of some multimodal services, for example, an extended reality (extended reality, XR) multimodal service, often need to meet a multimodal relationship. If the plurality of data flows belong to a same terminal device, the terminal device may schedule the plurality of data flows by using, for example, control information of a user plane and/or control information of a control plane, to implement the XR multimodal service.

Because the foregoing plurality of data flows belong to the same terminal device, a multimodal service has a relatively simple implementation. However, if the foregoing plurality of data flows belong to a plurality of terminal devices, how to implement the multimodal service is a technical problem to be resolved urgently.

### SUMMARY

The present application provides a wireless communication method, a communications device, and a terminal device. Various aspects used in the present application are described below.

According to a first aspect, a wireless communication method is provided, including: obtaining multimodal relationship information, where the multimodal relationship information is used to indicate a multimodal relationship between a plurality of data flows, and the plurality of data flows belong to a plurality of terminal devices; and scheduling the plurality of data flows of the plurality of terminal devices based on the multimodal relationship information.

According to a second aspect, a wireless communication method is provided, including: transmitting first information to a first base station, where the first information includes multimodal relationship information, the multimodal relationship information is used to indicate a multimodal relationship between a plurality of data flows, and the plurality of data flows belong to a plurality of terminal devices.

According to a third aspect, a wireless communication method is provided, including: transmitting second information to a first base station, where the second information includes multimodal relationship information, the multimodal relationship information is used to indicate a multimodal relationship between a plurality of data flows, the plurality of data flows belong to a plurality of terminal devices, and a first terminal device is one of the plurality of terminal devices.

According to a fourth aspect, a communications device is provided, where the communications device is a first base station, and the communications device includes: an obtaining unit, obtaining multimodal relationship information, where the multimodal relationship information is used to indicate a multimodal relationship between a plurality of data flows, and the plurality of data flows belong to a plurality of terminal devices; and a scheduling unit, scheduling the plurality of data flows of the plurality of terminal devices based on the multimodal relationship information.

According to a fifth aspect, a core network device is provided, including: a transmission unit, transmitting first information to a first base station, where the first information includes multimodal relationship information, the multimodal relationship information is used to indicate a multimodal relationship between a plurality of data flows, and the plurality of data flows belong to a plurality of terminal devices.

According to a sixth aspect, a terminal device is provided, where the terminal device is a first terminal device, and the first terminal device includes: a first transmission unit, transmitting second information to a first base station, where the second information includes multimodal relationship information, the multimodal relationship information is used to indicate a multimodal relationship between a plurality of data flows, the plurality of data flows belong to a plurality of terminal devices, and the first terminal device is one of the plurality of terminal devices.

According to a seventh aspect, a communications device is provided, where the communications device is a first base station, and the communications device includes a processor, a memory, and a communications interface. The memory is configured to store one or more computer programs, and the processor is configured to invoke the computer program in the memory to cause the communications device to perform some or all of the steps of the method according to the first aspect.

According to an eighth aspect, a communications device is provided, where the communications device is a core network device, and the communications device includes a processor, a memory, and a communications interface. The memory is configured to store one or more computer programs, and the processor is configured to invoke the computer program in the memory to cause the communications device to perform some or all of the steps in the method according to the second aspect.

According to a ninth aspect, a terminal device is provided, including a processor, a memory, and a communications interface. The memory is configured to store one or more computer programs, and the processor is configured to invoke the computer program in the memory, to cause the terminal device to perform some or all of the steps in the method according to the third aspect.

According to a tenth aspect, an embodiment of the present application provides a communications system, where the system includes the communications device and/or the terminal device described above. In another possible design, the system may further include another device that interacts with the communications device or the terminal device in the solutions provided in embodiments of the present application.

According to an eleventh aspect, an embodiment of the present application provides a computer-readable storage medium. The computer-readable storage medium stores a computer program, and the computer program causes a terminal device to perform some or all of the steps in the method according to the first aspect, the second aspect, or the third aspect.

According to a twelfth aspect, an embodiment of the present application provides a computer program product. The computer program product includes a non-transitory computer-readable storage medium that stores a computer program, and the computer program is operable to cause a terminal device to perform some or all of the steps in the method according to the first aspect, the second aspect, or the third aspect. In some implementations, the computer program product may be a software installation package.

According to a thirteenth aspect, an embodiment of the present application provides a chip. The chip includes a memory and a processor, and the processor may invoke a computer program from the memory and run the computer program, to implement some or all of the steps described in the method according to the first aspect, the second aspect, or the third aspect.

In embodiments of the present application, a communications device (for example, a first base station) may first obtain a multimodal relationship between a plurality of data flows. Then the first base station schedules the plurality of data flows of a plurality of terminal devices based on the multimodal relationship, so that a multimodal service between the plurality of terminal devices can be implemented.

### BRIEF DESCRIPTION OF THE DRAWINGS

FIG. 1 is a schematic diagram of a wireless communications system to which embodiments of the present application are applied.

FIG. 2 is an example diagram of a transmission time sequence of a data flow.

FIG. 3 is a schematic flowchart of a wireless communication method according to an embodiment of the present application.

FIG. 4 is a schematic flowchart of another possible wireless communication method according to an embodiment of the present application.

FIG. 5 is a schematic flowchart of another possible wireless communication method according to an embodiment of the present application.

FIG. 6 is a possible example diagram of obtaining multimodal relationship information according to an embodiment of the present application.

FIG. 7 is another possible example diagram of obtaining multimodal relationship information shown in FIG. 6.

FIG. 8 is another possible example diagram of obtaining multimodal relationship information according to an embodiment of the present application.

FIG. 9 is a schematic flowchart of another possible wireless communication method according to an embodiment of the present application.

FIG. 10 is a schematic flowchart of another possible wireless communication method according to an embodiment of the present application.

FIG. 11 is a schematic structural diagram of a communications device according to an embodiment of the present application.

FIG. 12 is a schematic structural diagram of another communications device according to an embodiment of the present application.

FIG. 13 is a schematic structural diagram of a terminal device according to an embodiment of the present application.

FIG. 14 is a schematic structural diagram of an apparatus according to an embodiment of the present application.

### DETAILED DESCRIPTION OF THE EMBODIMENTS

The technical solutions in the present application are described below with reference to the accompanying drawings.

### Communications System

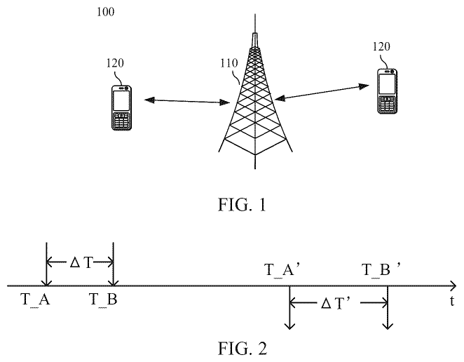

FIG. 1 shows a wireless communications system 100 to which embodiments of the present application are applied. The wireless communications system 100 may include a communications device 110 and a terminal device 120. The communications device 110 may be a device that communicates with the terminal device 120.

FIG. 1 exemplarily shows one communications device and two terminals. Optionally, the wireless communications system 100 may include a plurality of communications devices, and another quantity of terminal devices may be included within a coverage of each communications device. This is not limited in embodiments of the present application.

Optionally, the wireless communications system 100 may further include other network entities such as a network controller and a mobility management entity. This is not limited in embodiments of the present application.

It should be understood that the technical solutions in embodiments of the present application may be applied to various communications systems, such as a 5th generation (5th generation, 5G) system or a new radio (new radio, NR) system, a long term evolution (long term evolution, LTE) system, an LTE frequency division duplex (frequency division duplex, FDD) system, and an LTE time division duplex (time division duplex, TDD) system. The technical solutions provided in the present application may further be applied to a future communications system, such as a 6th generation mobile communications system or a satellite communications system.

A terminal device in embodiments of the present application may alternatively be referred to as a user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a wireless communications device, a user agent, or a user apparatus. The terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self driving (self driving), a wireless terminal in remote medical surgery (remote medical surgery), a wireless terminal in a smart grid (smart grid), a wireless terminal in transportation safety (transportation safety), a wireless terminal in a smart city (smart city), a wireless terminal in a smart home (smart home), or the like. Optionally, the UE may be configured to function as a base station. For example, the UE may function as a scheduling entity that provides a sidelink signal between UEs in vehicle-to-everything (vehicle-to-everything, V2X), device-to-device (device to device, D2D), or the like. For example, a cellular phone and a vehicle communicate with each other by using a sidelink signal. A cellular phone and a smart home device communicate with each other, without relay of a communication signal through a base station.

A communications device in embodiments of the present application may be a device configured to communicate with a terminal device. The communications device may include an access network device, for example, a base station device. The access network device may provide a communication coverage for a specific geographic area, and may communicate with the terminal device 120 located in the coverage. The access network device may alternatively be referred to as a radio access network device, a base station, or the like. The access network device in embodiments of the present application may be a radio access network (radio access network, RAN) node (or device) that connects the terminal device to a wireless network. The access network device may broadly cover the following various names, or may be replaced with the following names, such as a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB (master eNB, MeNB), a secondary eNodeB (secondary eNB, SeNB), a multi-standard radio (multi-standard radio, MSR) node, a home base station, a network controller, an access node, a radio node, an access point (access point, AP), a transmission node, a transceiver node, a baseband unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node, and the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that assumes functions of a base station in D2D, V2X, and machine-to-machine (machine-to-machine, M2M) communications, a network-side device in a 6G network, a device that assumes functions of a base station in a future communications system, or the like. The base station may support networks with a same access technology or different access technologies. A specific technology and a specific device form used by the access network device are not limited in embodiments of the present application.

The base station may be fixed or mobile. For example, a helicopter or an unmanned aerial vehicle may be configured to function as a mobile base station, and one or more cells may move according to a location of the mobile base station. In other examples, a helicopter or an unmanned aerial vehicle may be configured to function as a device in communication with another base station.

The communications device in the wireless communications system may further include a core network device.

The core network device in embodiments of the present application may include a network element that processes and forwards signalling and data from a user. For example, the core network device may include a core network access and mobility management function (access and mobility management function, AMF), a session management function (session management function, SMF), a user plane gateway, an application function (application function, AF), a location management function (location management function, LMF), and other core network devices. The AF may be a functional network element configured to provide various services. The AF may be connected to an external server (for example, an XR server). The user plane gateway is usually located on a network side, and may be a server having functions such as mobility management, routing, and forwarding of user plane data, such as a serving gateway (serving gateway, SGW), a packet data network gateway (packet data network gateway, PGW), a user plane function (user plane function, UPF), or the like. Certainly, a core network may further include another network element. Examples are not listed herein one by one.

In some deployments, the communications device in embodiments of the present application may be a CU or a DU, or the communications device includes a CU and a DU. The gNB may further include an AAU.

The communications device and the terminal device may be deployed on land, including being indoors or outdoors, handheld, or vehicle-mounted, may be deployed on a water surface, or may be deployed on a plane, a balloon, or a satellite in the air. A scenario in which the communications device and the terminal device are located is not limited in embodiments of the present application.

It should be understood that all or some of functions of the communications device in the present application may alternatively be implemented by software functions running on hardware, or by virtualization functions instantiated on a platform (for example, a cloud platform).

### XR

The XR may be implemented by a computer technology and a wearable device. The XR may include representative forms such as augmented reality (augmented reality, AR), mixed reality (mixed reality, MR), and virtual reality (virtual reality, VR). The VR technology may simulate an object and a background of a real world by using a computer, and may provide, to a user, a virtual object and a virtual background that are simulated. The AR technology may provide, on an image of the real world, a virtual object that is virtually made. The MR technology may combine a virtual reality with the real world to provide an environment in which a real physical object interacts with a virtual object. It should be understood that XR service data may include a plurality of types such as video data, audio data, and tactile data.

### Multimodal Service

The multimodal service may be a group of data between which a multimodal relationship exists. The multimodal relationship may be a sequential and temporal transmission relationship between a plurality of data flows in the multimodal service. For example, a plurality of data flows (such as a video data flow and a tactile data flow) of an extended reality XR multimodal service often need to meet the multimodal relationship. The following describes the multimodal relationship in detail by using a data packet A in the video data flow and a data packet B in the tactile data flow as an example.

With reference to FIG. 2, a data source may first transmit the data packet A at an instant T_A, and transmit the data packet B at an instant T_B after the instant T_A, where a time interval between T_A and T_B is required to be less than ΔT. In addition, when being submitted to a receiver, the two data packets are also required to follow a certain time relationship. For example, a network submits the data packet A to the receiver at an instant T_A′, and submits the data packet B to the receiver at an instant T_B′, where a time interval between T_A′ and T_B′ is required to be less than ΔT′. Currently, for a multimodal service scenario of a same terminal device, it is proposed in the related art that the terminal device may be configured to schedule a plurality of data flows of the multimodal service, to enable the plurality of data flows to meet the multimodal relationship. For example, the terminal device may schedule the plurality of data flows based on the multimodal relationship by using control information of a user plane, to implement the multimodal service. Because the foregoing plurality of data flows belong to the same terminal device, the multimodal service has a relatively simple implementation. However, if the foregoing plurality of data flows belong to a plurality of terminal devices, how to implement the multimodal service is a technical problem to be resolved urgently.

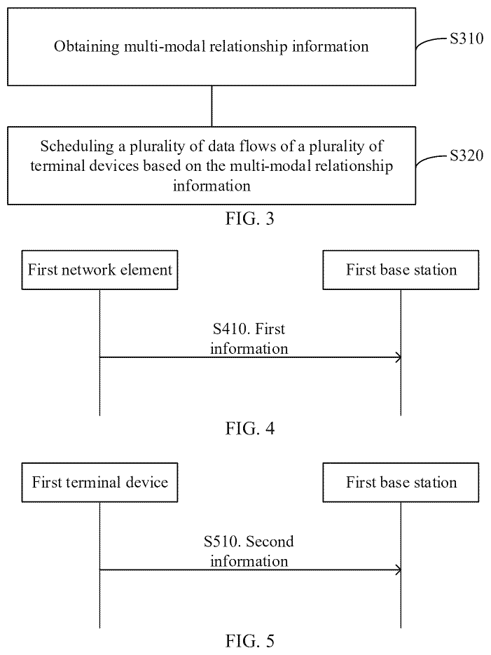

To resolve the foregoing problem, with reference to FIG. 3, in embodiments of the present application, a communications device (for example, a first base station) first obtains a multimodal relationship between a plurality of data flows (with reference to Step S310 in FIG. 3). Then, the first base station schedules the plurality of data flows of a plurality of terminal devices based on the multimodal relationship (with reference to Step S320 in FIG. 3), so that a multimodal service between the plurality of terminal devices can be implemented. With reference to FIG. 3, the following describes a wireless communication method in more detail according to an embodiment of the present application.

In Step S310, the first base station obtains multimodal relationship information.

In some implementations, the first base station may be an access network device of any type described above. The first base station may be, for example, the communications device 110 in FIG. 1.

The multimodal relationship information of the plurality of data flows may be used to indicate the multimodal relationship between the plurality of data flows, and the plurality of data flows belong to the plurality of terminal devices.

In some implementations, the plurality of data flows may belong to a data flow of a same service type. For example, the plurality of data flows may belong to a data flow of a video service. The plurality of data flows may alternatively belong to data flows of different service types. For example, some of the plurality of data flows may belong to a data flow of a video service, and some of the plurality of data flows may belong to a data flow of a tactile service and/or a data flow of an audio service.

In some embodiments, the first base station may obtain the multimodal relationship information of the plurality of data flows from a core network, or may obtain the multimodal relationship from a terminal device. With reference to FIG. 4, the following describes a detailed example of obtaining the multimodal relationship information from the core network.

With reference to FIG. 4, in Step S410, a first network element of the core network may transmit first information to a first base station. The first information includes the multimodal relationship information of the plurality of data flows, and the first information may be carried in a session setup request (session setup request) message.

In some implementations, the first network element may include one or more of the following network elements: an access and mobility management function AMF, a session management function SMF, or an application function AF. When the first network element is the AMF, the first network element may directly transmit the multimodal relationship information of the plurality of data flows to the first base station. When the first network element is the SMF or the AF, the first network element may indirectly transmit the multimodal relationship information to the first base station by using the AMF network element.

In some implementations, the first network element may be configured to communicate with a server of the plurality of data flows, to obtain the multimodal relationship information of the plurality of data flows from the server.

In some implementations, the server may transmit the multimodal relationship information of the plurality of data flows to the AF, then the AF transmits the multimodal relationship information to the SMF, next the SMF transmits the multimodal relationship information to the AMF, and finally the AMF transmits the multimodal relationship information to the first base station. That is, the server may transmit the multimodal relationship information to the first base station by using network elements AF-SMF-AMF of the core network.

In some implementations, the plurality of data flows may be data in an XR multimodal service, or data in a multimodal service of federated learning or in a multimodal service of another type. This is not limited in the present application. It should be understood that when the plurality of data flows belong to the data in the XR multimodal service, the server of the plurality of data flows is an XR server. When the plurality of data flows belong to the data in the multimodal service of federated learning, the server of the plurality of data flows is a federated learning server.

In some implementations, if the plurality of terminal devices respectively fall within coverages of a plurality of base station devices (such as the first base station and a second base station), the plurality of base station devices are connected to terminal devices in cell coverages corresponding to the base station devices. The first network element may transmit a multimodal relationship between data flows of a plurality of terminal devices in the cell coverages of the plurality of base station devices to the first base station, so that the first base station can determine a time sequence relationship between the plurality of data flows. Certainly, the first network element may alternatively transmit a multimodal relationship between data flows of a terminal device in a cell coverage of only the first base station to the first base station. The following descriptions are provided with reference to the examples.

For example, if the plurality of base stations include the first base station and the second base station, and the plurality of terminal devices include the first terminal device, a second terminal device, and a third terminal device, the first terminal device and the second terminal device are located in the cell coverage of the first base station, and the first terminal device and the second terminal device are both connected to the first base station; and the third terminal device is located in a cell coverage of the second base station, and the third terminal device is connected to the second base station. The plurality of data flows include a first data flow, a second data flow, and a third data flow. The first data flow belongs to a data flow of the first terminal device, the second data flow belongs to a data flow of the second terminal device, and the third data flow belongs to a data flow of the third terminal device.

In some examples, a first network element may transmit a multimodal relationship between the data flows of the plurality of terminal devices in the cell coverages of the plurality of base station devices to the first base station. For example, the first network element may transmit multimodal relationship information of the first data flow, the second data flow, and the third data flow to the first base station. Certainly, the first network element may alternatively transmit the multimodal relationship information of the first data flow, the second data flow, and the third data flow to the second base station.

In some other examples, the first network element may transmit a multimodal relationship between the data flows of the plurality of terminal devices in the cell coverage of the first base station to the first base station. For example, the first network element may transmit multimodal relationship information of the first data flow and the second data flow to the first base station.

It should be understood that the second base station may be a base station device different from the first base station, and the second base station may be a base station device of any type described above.

It should be understood that the multimodal relationship information of the first data flow, the second data flow, and the third data flow may be used to indicate that a multimodal relationship exists between the first data flow, the second data flow, and the third data flow. Similarly, the multimodal relationship information of the first data flow the second data flow may be used to indicate that a multimodal relationship exists between the first data flow and the second data flow.

The foregoing mainly describes a perspective from which the first base station obtains the multimodal relationship information from the core network. With reference to FIG. 5, the following describes a detailed example of a perspective from which a first base station obtains multimodal relationship information from a terminal device.

With reference to FIG. 5, in Step S510, a first terminal device may transmit second information to the first base station. The second information includes the multimodal relationship information of the plurality of data flows described above. It should be understood that the first terminal device is any one of a plurality of terminal devices.

That is, the first base station may receive one or more pieces of information from some or all of the plurality of terminal devices, to obtain the multimodal relationship information of the plurality of data flows.

In some implementations, the second information may be carried in a radio resource control (radio resource control, RRC) message. For example, the second information may be carried in UE assistance information (UE assistance information) in the RRC message.

In some implementations, an access layer of the first terminal device may transmit the multimodal relationship information of the plurality of data flows to the first base station by using the RRC message.

In some implementations, a client of the first terminal device may transmit the multimodal relationship information of the plurality of data flows to the access layer of the first terminal device. Then, the access layer of the first terminal device may transmit the multimodal relationship information of the plurality of data flows to the first base station by using the RRC message. It should be understood that the client of the first terminal device may communicate with a server of the plurality of data flows, to obtain the multimodal relationship information.

In some implementations, the second information may alternatively be carried in a MAC CE message, that is, the first terminal device may transmit the multimodal relationship information of the plurality of data flows to the first base station by using the MAC CE message.

It should be understood that the first terminal device may transmit some or all of the multimodal relationship information of the plurality of data flows to the first base station. This is not limited in the present application.

It should be understood that when the first terminal device transmits the multimodal relationship information to the first base station, the first terminal device further needs to notify the first base station of another terminal device for which a multimodal service exists between the another terminal device and the first terminal device, so that the first base station schedules data flows of the plurality of terminal devices. Therefore, the first terminal device may further transmit an application layer identity or another upper-layer identity of a second terminal device to the first base station. The second terminal device may be any one of the plurality of terminal devices except the first terminal device.

In some implementations, the second information may further include the application layer identity of the second terminal device.

It should be understood that because the client of the first terminal device belongs to an application layer, when transmitting an identity of the second terminal device to the first base station, the client of the first terminal device can transmit only the application layer identity of the second terminal device to the first base station device. However, the first base station cannot identify the application layer identity of the second terminal device. Therefore, the first base station further needs to determine the identity of the second terminal device. As an example, if the second terminal device and the first terminal device belong to a same cell, the first base station needs to determine an access network identity C-RNTI of the second terminal device; or if the second terminal device and the first terminal device belong to different cells, the first base station needs to determine a core network identity S-TMSI of the second terminal device.

In some implementations, the first base station may be configured to determine the access network identity of the second terminal device based on the application layer identity of the second terminal device. For example, the first base station may determine the access network identity C-RNTI of the second terminal device according to the application layer identity of the second terminal device by querying a core network or a server of the plurality of data flows. Then, the first base station may schedule a data flow of the second terminal device according to the access network identity of the second terminal device based on the multimodal relationship.

In some implementations, manners of obtaining a multimodal relationship of a same service by the first base station may be combined for use. As an example, the first base station may obtain a multimodal relationship between a plurality of data flows in a same service from both a first terminal device side and a core network side. For example, the first base station may obtain a multimodal relationship between a plurality of uplink data flows from the first terminal device side, and obtain a multimodal relationship between a plurality of downlink data flows from the core network side. Certainly, the first base station may alternatively obtain a multimodal relationship between a plurality of downlink data flows from the first terminal device side, and obtain a multimodal relationship between a plurality of uplink data flows from the core network side.

In Step S320, the first base station schedules the plurality of data flows of the plurality of terminal devices based on the multimodal relationship information.

In some implementations, when the plurality of terminal devices are located in a same cell, a scheduling manner of the plurality of terminal devices may be a group scheduling manner. That is, the first base station may schedule the plurality of data flows of the plurality of terminal devices in the group scheduling manner based on the multimodal relationship information, thereby facilitating reducing air interface consumption of the first base station and improving the scheduling efficiency.

As an example, an application scenario of group scheduling may be: A plurality of users participate in a same game, and the users may be geographically located in a same cell.

In some implementations, in the scenario of the group scheduling, before the first base station schedules the plurality of data flows of the plurality of terminal devices based on the multimodal relationship information, the first base station is further configured to configure, for the plurality of terminal devices, an identity of the group scheduling and/or delay information associated with the identity of the group scheduling.

As an example, the first base station may transmit configuration information to the plurality of terminal devices, to configure the identity of the group scheduling and the delay information of the plurality of terminal devices. The first terminal device is used as an example. The first base station may transmit first configuration information to the first terminal device among the plurality of terminal devices, and the first configuration information is used to indicate one or more of the following: a first identity used for group scheduling; or delay information associated with a first identity.

In some implementations, the first identity may be a group identity (for example, a G-RNTI); or the first identity may be an identity of the first terminal device (for example, an access network identity C-RNTI).

As an example, it is assumed that an identity used by a terminal device UE 1 for group scheduling is a group identity G-RNTI 1, delay information associated with the G-RNTI 1 (for example, delay information for transmitting a data flow to the UE 1 with the identity of the G-RNTI 1) is 0 ms, an identity used by a terminal device UE 2 for group scheduling is a group identity G-RNTI 2, delay information associated with the G-RNTI 2 (for example, delay information for transmitting a data flow to the UE 2 with the identity of the G-RNTI 2) is 2 ms, an identity used by a terminal device UE 3 for group scheduling is a group identity G-RNTI 3, and delay information associated with the G-RNTI 3 (for example, delay information for transmitting a data flow to the UE 3 with the identity of the G-RNTI 3) is 4 ms. In this case, the first base station may transmit a data flow X (a flow X) to the UE 1 at an instant T, transmit a data flow Y (a flow Y) to the UE 2 at an instant T+2, and transmit a data flow Z (a flow Z) to the UE 3 at an instant T+4.

It should be noted that values of group identities used for group scheduling may be the same. For example, values of the group identities G-RNTI 1, G-RNTI 2 and G-RNTI 3 may be the same.

In some implementations, the first base station may schedule a data flow of a terminal device by using downlink control information (downlink control information, DCI).

As an example, the first base station may transmit second DCI to the first terminal device, and the second DCI may be used to schedule a data flow of the first terminal device. Then the first terminal device may receive the data flow of the first terminal device based on the second DCI. The first terminal device may be any one of the plurality of terminal devices. That is, the first base station may transmit corresponding DCI to each of the plurality of terminal devices, to schedule the data flow of the plurality of terminal devices.

In some embodiments, if a first data flow of the first terminal device among the plurality of terminal devices is transmitted earlier than a second data flow of the second terminal device among the plurality of terminal devices, in a process in which the first base station schedules the data flow of a terminal device by using the DCI, the second terminal device may infer, based on DCI of the first data flow and delay information of the second data flow, a time-frequency resource on which the second data flow of the second terminal device is located. In this scenario, the first base station does not need to transmit the DCI to another terminal device (for example, the second terminal device) different from the first terminal device, thereby facilitating saving downlink network resources of the first base station.

In some implementations, the DCI of the first data flow may be transmitted through G-RNTI scrambling, or the DCI of the first data flow may be transmitted through C-RNTI scrambling of the first terminal device. This is not specifically limited in the present application.

In some implementations, when the first base station schedules the data flow of the first terminal device by using first DCI, the following step is further included: The first base station transmits a data flow (for example, the first data flow) of the first terminal device to the first terminal device.

In some implementations, the plurality of terminal devices include the first terminal device and the second terminal device, the first base station may transmit the first DCI to the first terminal device, and the first DCI may be used to schedule the data flow of the first terminal device.

In some implementations, the first DCI is further used to indicate a data flow of the second terminal device among the plurality of terminal devices. That is, in addition to the first terminal device, the other terminal devices among the plurality of terminal devices further need to monitor DCI of the other terminal devices. For example, the first base station is further configured to transmit second DCI to the second terminal device, and the second DCI may be used to schedule the data flow of the second terminal device.

In some implementations, the first DCI is further used to schedule the data flow of the second terminal device among the plurality of terminal devices. That is, in addition to the first terminal device, the other terminal devices among the plurality of terminal devices do not need to monitor DCI of the other terminal devices. As long as obtaining the first DCI through monitoring, the other terminal devices may infer a time-frequency resource location of local data by using the first DCI.

In some implementations, when the plurality of terminal devices respectively fall within coverages of a plurality of base station devices (such as the first base station and the second base station), the plurality of base station devices may be configured to jointly schedule the plurality of data flows of the plurality of terminal devices, to implement a multimodal service.

It should be noted that when the plurality of base station devices jointly schedule the plurality of data flows of the plurality of terminal devices, the plurality of base stations may communicate with each other. For example, the plurality of base stations may exchange information through an Xn interface.

In some implementations, before the plurality of base station devices jointly schedule the plurality of data flows of the plurality of terminal devices, the plurality of base station devices (such as the first base station and the second base station) may first negotiate a scheduling time sequence of the plurality of data flows. The plurality of base station devices negotiating the scheduling time sequence of the plurality of data flows may be that the plurality of base station devices align scheduling times of the plurality of data flows. Then, the plurality of base stations may schedule the plurality of data flows based on the multimodal relationship and the aligned times, to meet the multimodal service.

As an example, the plurality of base station devices negotiating the scheduling time sequence of the plurality of data flows is that the plurality of base station devices may negotiate the scheduling time sequence of the plurality of data flows based on clock signals. The first data flow and the third data flow that are described above are used as an example. For example, a clock signal (for example, 12:00:00) of the first data flow corresponds to a clock signal (for example, 12:00:00) of the third data flow. Then the plurality of base stations may schedule the plurality of data flows of the plurality of terminal devices based on the above multimodal relationship and the aligned clock signals (that is, a scheduling time sequence).

As another example, the plurality of base station devices negotiating the scheduling time sequence of the plurality of data flows is that the plurality of base station devices may negotiate the scheduling time sequence of the plurality of data flows based on system frame numbers (system frame number, SFN). The first data flow and the third data flow that are described above are used as an example. For example, a system frame number SFN 5 of the first data flow corresponds to a system frame number SFN 437 of the third data flow. For another example, a system frame number SFN 6 of the first data flow corresponds to a system frame number SFN 438 of the third data flow. The rest can be obtained in the same manner. Then the plurality of base stations may schedule the plurality of data flows of the plurality of terminal devices based on the above multimodal relationship and the aligned system frame numbers. The following describes, by using an example in which system frame numbers SFN are aligned, a manner in which the plurality of base stations jointly schedule the data flows of the plurality of terminal devices.

As an example, if the plurality of base stations include the first base station and the second base station that are described above, a system frame number SFN 5 of the first data flow corresponds to a system frame number SFN 437 of the third data flow, and a multimodal relationship between the first data flow and the third data flow is that the first data flow is transmitted 30 ms earlier than the third data flow. In this case, the first base station may transmit the first data flow to the first terminal device at an instant “SFN=5”, and the second base station may transmit the third data flow to the third terminal device at an instant “SFN=440” after three SFNs.

As described above, if the plurality of terminal devices respectively fall within coverages of the plurality of base station devices (such as the first base station and the second base station), when a first network element transmits the multimodal relationship information of the plurality of data flows to the first base station, the first network element may filter the multimodal information, to ensure data security and maintain an existing architecture of the first network element. In this way, the first base station cannot obtain the multimodal relationship between the first data flow and the third data flow that are described above, and the second base station also cannot obtain the multimodal relationship between the third data flow, the first data flow, and the second data flow. In this case, a second network element (for example, a UPF) may schedule the plurality of data flows of the plurality of terminal devices.

As an example, if the multimodal relationship between the first data flow and the third data flow is that the first data flow is transmitted earlier than the third data flow by a first time period (for example, 30 ms), the second network element may first transmit the first data flow to the first base station, and then transmit the third data flow to the second base station after the first time period. In this way, the second network element may indirectly control an air interface transmission time sequence of a base station device by controlling an occasion of transmitting a data flow to the base station device (such as the first base station and the second base station), so that a multimodal service function can be implemented.

As described above, if the plurality of terminal devices respectively fall within the coverages of the plurality of base station devices (such as the first base station and the second base station), the first network element may transmit a multimodal relationship between data flows of the plurality of terminal devices in the coverages of the plurality of base station devices to the first base station, so that the first base station can determine a time sequence relationship between the plurality of data flows. In this case, the first network element does not need to filter the multimodal relationship information of the plurality of data flows. The plurality of base stations may schedule the data flows of the plurality of terminal devices based on the multimodal relationship. The following describes an example of the joint scheduling manner.

As an example, if the multimodal relationship between the first data flow and the third data flow is that the first data flow is transmitted earlier than the third data flow by a first time period (for example, 30 ms), a transmission instant of the first data flow is a first instant. The first base station may transmit the first data flow at the first instant (for example, the foregoing instant SFN 5) based on the multimodal relationship. The second base station may transmit the third data flow at a second instant (for example, the foregoing instant SFN 440) based on the multimodal relationship. The second instant is later than the first instant by the first time period, so that the multimodal service function of the plurality of data flows can be implemented.

It should be understood that the second base station already obtains transmission time information of the first data flow before transmitting the third data flow at the second instant, so that the second base station can determine to transmit the third data flow at the second instant based on the multimodal relationship. The following describes an example of a manner of the base station device obtaining transmission time information of a data flow.

In some implementations, the second network element may transmit, to a base station device, transmission time information of a data flow of a base station corresponding to the base station device. For example, the second network element may transmit transmission time information of the third data flow of the second base station to the first base station device.

As an example, if the multimodal relationship between the first data flow and the third data flow is that the first data flow is transmitted later than the third data flow by a first time period (for example, 30 ms), and a transmission instant of the third data flow is a first instant, the second network element in the core network transmits the first data flow to the first base station, and the first data flow includes the transmission time information of the third data flow (for example, the second base station transmits the third data flow at the first instant). In this way, the first base station may transmit the first data flow at a second instant based on the transmission time information of the third data flow. In this case, the second instant is later than the first instant by the first time period.

In some implementations, if the multimodal relationship between the first data flow and the third data flow is that the first data flow is transmitted earlier than the third data flow by a first time period (for example, 30 ms), and a transmission instant of the first data flow is a first instant, the first base station may transmit transmission time information of the first data flow to the second network element of the core network. The transmission time information may be, for example, that the first base station transmits the first data flow at the first instant.

It should be noted that before the first base station transmits the transmission time information of the first data flow to the second network element of the core network, the first base station may further learn that a third terminal device among the plurality of terminal devices is connected to the second base station. That is, the first base station may learn that terminal devices in a same group are located in a cell coverage of the second base station.

In some implementations, if the multimodal relationship between the first data flow and the third data flow is that the first data flow is transmitted earlier than the third data flow by a first time period (for example, 30 ms), and a transmission instant of the first data flow is a first instant, the first base station may transmit transmission time information of the first data flow to the second network element after receiving the first data flow transmitted by the second network element.

In some implementations, the second network element may be a user plane network element function entity UPF.

It may be seen from the foregoing content descriptions that, in embodiments of the present application, the first base station may first obtain the multimodal relationship between the plurality of data flows. Then the first base station schedules the plurality of data flows of the plurality of terminal devices based on the multimodal relationship, so that a multimodal service between the plurality of terminal devices can be implemented.

It should be noted that the multimodal relationship in embodiments of the present application may be effective for both an uplink and a downlink, or only an uplink or a downlink may be configured, that is, a multimodal relationship between uplink data flows is independent of a multimodal relationship between downlink data flows.

It should be understood that for the downlink data flow, a time sequence relationship may be considered during scheduling; and for the uplink data flow, a time sequence relationship may be considered during allocation of an uplink resource.

As an example, if the plurality of base stations include a first base station and a second base station, the plurality of terminal devices include a first terminal device, a second terminal device, and a third terminal device, the first terminal device and the second terminal device are connected to the first base station, and the third terminal device is connected to the second base station. The plurality of data flows include a first data flow, a second data flow, and a third data flow. The first data flow belongs to a data flow of the first terminal device, the second data flow belongs to a data flow of the second terminal device, and the third data flow belongs to a data flow of the third terminal device. A time sequence relationship between the plurality of data flows includes that the first data flow is submitted earlier than the second data flow, and that the first data flow is submitted earlier than the third data flow. For the first terminal device and the second terminal device in a cell of a same base station, when allocating uplink resources, based on the above time sequence relationship, the first base station first schedules the first data flow of the first terminal device, and then schedules the second data flow of the second terminal device. For the first terminal device and the third terminal device in different cells of different base stations, the first base station and the second base station may coordinate a scheduling time sequence of data, the first base station first schedules the first data flow of the first terminal device, and the second base station then schedules the third data flow of the third terminal device.

In some implementations, the multimodal relationship may be a transmission time sequence relationship existing between the plurality of data flows, and the multimodal relationship may include one or more of the following time sequence relationships: a time sequence relationship between downlink data transmitted by a base station or another network device (for example, a UPF) to a terminal device; a time sequence relationship between downlink data submitted by an access layer of a terminal device to an upper layer; a time sequence relationship between uplink data transmitted by a terminal device to a base station; or a time sequence relationship between uplink data submitted by a base station to a network element of the core network.

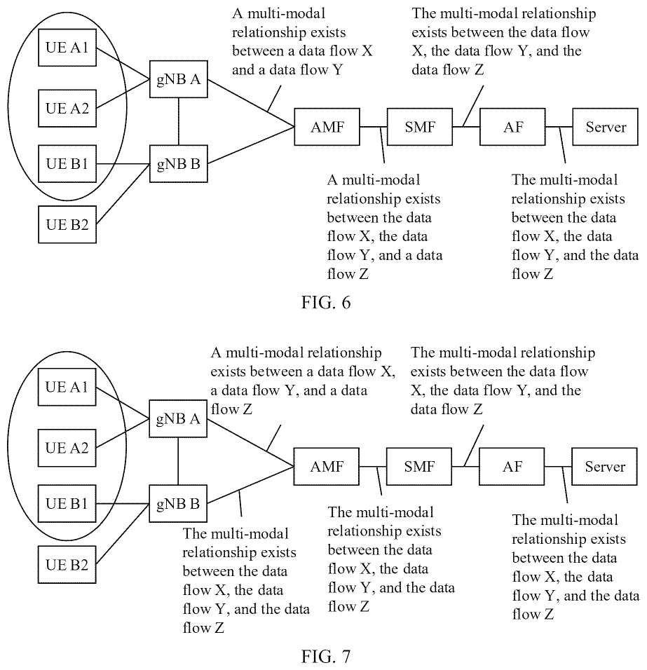

As mentioned above, the first base station may obtain the multimodal relationship information of the plurality of data flows from the core network. The following describes a more detailed example of obtaining the multimodal relationship information from the core network with reference to FIG. 6 and FIG. 7. FIG. 6 is a schematic diagram of a possible architecture of obtaining multimodal relationship information from a core network according to an embodiment of the present application. It should be understood that a multimodal relationship exists between a data flow X (a flow X) of a terminal device UE A1, a data flow Y (a flow Y) of a terminal device UE A2, and a data flow Z (a flow Z) of a terminal device UE B1.

As shown in FIG. 6, a server may provide the multimodal relationship between the flow X, the flow Y, and the flow Z to an AMF by using an AF-SMF of the core network. In some implementations, the AMF filters the multimodal relationship information and notify only a base station of multimodal relationship information of data flows of a terminal device that is connected to the base station and that falls within a coverage of the base station. For example, the AMF notifies only a gNB A (for example, a first base station) that a multimodal relationship exists between the flow X and the flow Y, and does not notify a gNB B (for example, a second base station) that a multimodal relationship exists between the data flow Z, the data flow X, and the data flow Y. This facilitates improving the data transmission security and avoiding changes to an original communication architecture of the AMF.

FIG. 7 is a schematic diagram of another possible architecture of obtaining multimodal relationship information from a core network shown in FIG. 6.

With reference to FIG. 7, a server may provide a multimodal relationship between the flow X, the flow Y, and the flow Z to an AMF by using an AF-SMF of the core network. In some implementations, the AMF enhances the multimodal relationship information (for example, the AMF does not filter the multimodal relationship), and the AMF notifies a gNB A and a gNB B of the multimodal relationship between the flow X, the flow Y, and the flow Z. For example, the AMF notifies the gNB A of a multimodal relationship between the data flow X and the data flow Y, and a multimodal relationship also exists between the flow X, the flow Y, and the flow Z. For another example, the AMF notifies the gNB B of a multimodal relationship between the data flow Z, the data flow X, and the data flow Y.

As mentioned above, the first base station may obtain the multimodal relationship information of the plurality of data flows from the terminal device. With reference to FIG. 8, the following describes a more detailed example of obtaining multimodal relationship information from a terminal device. FIG. 8 is a schematic diagram of a possible architecture of obtaining multimodal relationship information from a terminal device according to an embodiment of the present application. It should be understood that a multimodal relationship exists between a data flow X (a flow X) of a terminal device UE A1 (for example, a first terminal device) and a data flow Y (a flow Y) of a terminal device UE A2 (not shown in the figure).

As shown in FIG. 8, a client of the UE A1 may be in a communication connection to a server. Therefore, the client of the UE A1 may obtain a multimodal relationship between the flow X and the flow Y. It should be understood that the client of the UE A1 belongs to an application layer, and the client may be an application program APP.

In some implementations, the application layer of the UE A1 transmits multimodal relationship information of the flow X and the flow Y to an access layer of the UE A1, and then the access layer of the UE A1 may transmit the multimodal relationship to a gNB A (for example, a first base station) by using an RRC message, or the access layer of the UE A1 may transmit the multimodal relationship to the gNB A by using a MAC CE message.

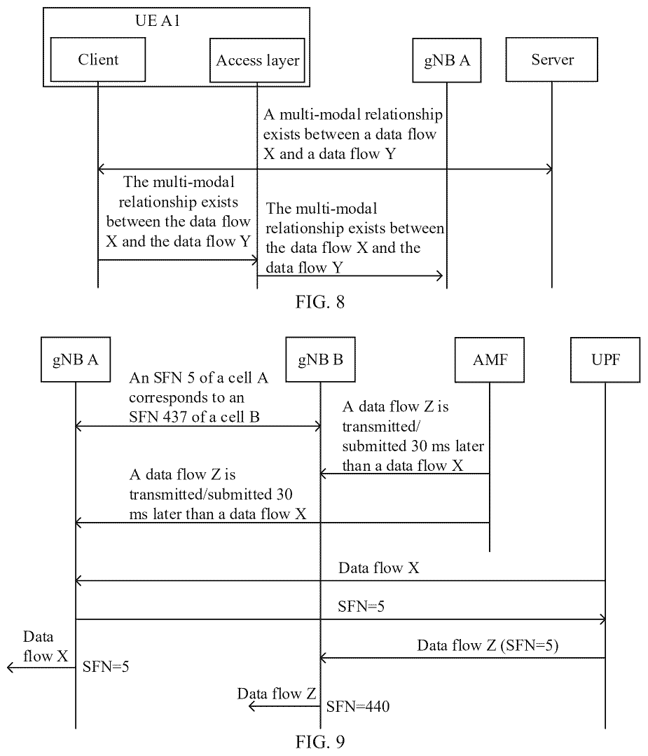

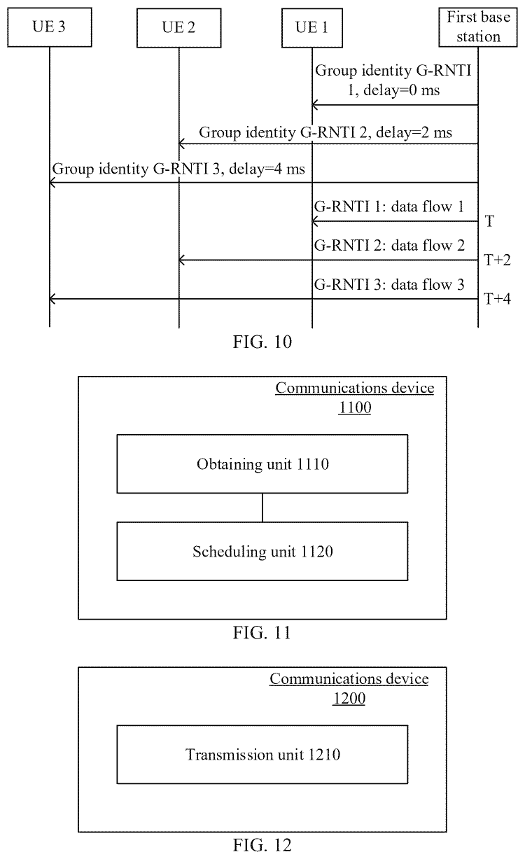

To deepen understanding of the wireless communication method in embodiments of the present application, the following describes a more detailed example of the wireless communication method with reference to FIG. 9 and FIG. 10. Assuming that a first terminal device falls within a coverage of a cell A of the gNB A (for example, a first base station), the first terminal device is connected to the gNB A. Assuming that a third terminal device falls within a coverage of a cell B of a gNB B (for example, a second base station), the third terminal device is connected to the gNB B. A multimodal relationship exists between a data flow X (a flow X) of the first terminal device and a data flow Z (a flow Z) of the third terminal device, and the flow X is transmitted or submitted earlier than the flow Z by 30 ms.

FIG. 9 is a schematic flowchart of another wireless communication method according to an embodiment of the present application. As shown in FIG. 9, the wireless communication method includes Steps S910 to S970.

In Step S910, a gNB A negotiates a scheduling time sequence of data with a gNB B. For example, an SFN 5 of a cell A of the gNB A corresponds to an SFN 437 of a cell B of the gNB B. For another example, an SFN 6 of a cell A corresponds to an SFN 438 of a cell B.

In Step S920, an AMF transmits multimodal relationship information of a flow X and a flow Y to the gNB A and the gNB B.

In Step S930, a UPF transmits the flow X to the gNB A.

In Step S940, after receiving the flow X, the gNB A notifies the UPF of a transmission instant of the flow X (it should be understood that the transmission instant may be a transmission instant that has occurred in the past or an instant corresponding to a future transmission behavior), for example, notifies the UPF that “the gNB A transmits the data flow X at the instant SFN 5”.

In Step S950, the UPF transmits a data flow Z to the gNB B, and forwards the data “the gNB A transmits the data flow X at the instant SFN 5”.

In Step S960, the gNB A transmits the data flow X to a first terminal device at the instant SFN 5.

In Step S970, the gNB B transmits the data flow Z to a third terminal device at an instant SFN 440 after three SFNs.

In some implementations, alternatively, the UPF may indirectly control a data transmission time sequence of an air interface of a base station device by controlling an occasion of data transmission to the base station device. For example, the UPF first transmits the data flow X to the gNB A, and then transmits the data flow Z to the gNB B after 30 ms.

In some implementations, terminal devices UE 1, UE 2, and UE 3 fall within a same cell coverage of a first base station. A multimodal relationship exists between a data flow 1 (a flow 1) of the UE 1, a data flow 2 (a flow 2) of the UE 2, and a data flow 3 (a flow 3) of the UE 3. The flow 1 is transmitted earlier than the flow 2 by 2 ms, and the flow 1 is transmitted earlier than a flow 4 by 2 ms. With reference to FIG. 10, the following describes an example of a scheduling manner of a plurality of data flows of a plurality of terminal devices in a same cell coverage.

FIG. 10 is a schematic flowchart of still another wireless communication method according to an embodiment of the present application. As shown in FIG. 10, the wireless communication method includes Steps S1010 to S1040.

In Step S1010, after obtaining a multimodal relationship between a flow 1, a flow 2, and a flow 3, a first base station may configure group identities G-RNTI for a UE 1, a UE 2, and a UE 3, and configure delay information of each UE.

It should be noted that a manner of configuring group identities and delay information of a plurality of terminal devices is not specifically limited in the present application. For example, the first base station may configure the group identities and the delay information of the plurality of terminal devices by using an RRC message or a MAC CE. For another example, the first base station may configure the group identities and the delay information of the plurality of terminal devices by using a multicast message, or the first base station may configure separately a group identity and delay information for each of the plurality of terminal devices.

In some implementations, a group identity of the UE 1 is a G-RNTI 1, and a data flow transmission delay of the UE 1 is 0 ms; a group identity of the UE 2 is a G-RNTI 2, and a data flow transmission delay of the UE 2 is 2 ms; and a group identity of the UE 3 is a G-RNTI 3, and a data flow transmission delay of the UE 3 is 4 ms.

In Step S1020, the first base station transmits the data flow 1 to the UE 1 at an instant T.

In Step S1030, the first base station transmits the data flow 2 to the UE 2 at an instant T+2.

In Step S1040, the first base station transmits the data flow 3 to the UE 3 at an instant T+4.

In some implementations, the first base station may notify the UE 2 and the UE 3 that the data is to be transmitted at the instant T. The first base station does not transmit DCI information at the instant T+2 or T+4. The UE 2 and the UE 3 infer wireless resources on which local data is located and a modulation mode based on DCI at the instant T.

In some implementations, the first base station may transmit DCI to the UE 1 at the instant T to instruct the UE 1 to receive the data flow of the UE 1; the first base station may transmit DCI to the UE 2 at the instant T+2 to instruct the UE 2 to receive the data flow of the UE 2; and the first base station may transmit DCI to the UE 3 at the instant T+4 to instruct the UE 3 to receive the data flow of the UE 3.

In some implementations, alternatively, the first base station may not use the group identity G-RNTI, but replace the group identity G-RNTI with an access network identity C-RNTI of a terminal device.

In some implementations, the first base station may first configure a time sequence relationship between the UE 1, the UE 2, and the UE 3, and then allocate uplink resources in sequence.

In some implementations, during allocation of the uplink resources, one uplink resource may be allocated to each of the UE 1, the UE 2, and the UE 3 once, or the uplink resources may be allocated three times, first to the UE 1, then to the UE 2, and the UE 3.

The foregoing describes the method embodiments of the present application in detail. The following describes apparatus embodiments of the present application in detail. It should be understood that the descriptions of the method embodiments correspond to the descriptions of the apparatus embodiments, and therefore, for a part that is not described in detail, reference may be made to the foregoing method embodiments.

FIG. 11 is a schematic structural diagram of a communications device according to an embodiment of the present application. The communications device is a first base station, and the communications device 1100 may include an obtaining unit 1110 and a scheduling unit 1120.

The obtaining unit 1110 is configured to obtain multimodal relationship information, where the multimodal relationship information is used to indicate a multimodal relationship between a plurality of data flows, and the plurality of data flows belong to a plurality of terminal devices.

The scheduling unit 1120 is configured to schedule the plurality of data flows of the plurality of terminal devices based on the multimodal relationship information.

In some implementations, the obtaining unit is configured to receive first information transmitted by a first network element of a core network, where the first information includes the multimodal relationship information.

In some implementations, the obtaining unit is configured to: the first base station receives second information transmitted by a first terminal device, where the second information includes the multimodal relationship information, and the first terminal device is one of the plurality of terminal devices.

In some implementations, the multimodal relationship information is used to indicate one or more of the following: a multimodal relationship exists between a first data flow and a second data flow; or a multimodal relationship exists between a first data flow and a third data flow. Both the first data flow and the second data flow belong to a data flow of a terminal device in a cell coverage of the first base station, the terminal device in the cell coverage of the first base station is connected to the first base station, the third data flow belongs to a data flow of a terminal device in a cell coverage of a second base station, and the terminal device in the cell coverage of the second base station is connected to the second base station.

In some implementations, the communications device further includes: a first transmission unit, transmitting transmission time information of the first data flow to a second network element of a core network.

In some implementations, the communications device further includes: a negotiation unit, negotiating a scheduling time sequence of data with the second base station.

In some implementations, the second information is carried in UE assistance information.

In some implementations, the plurality of terminal devices includes a second terminal device, and the second information includes an application layer identity of the second terminal device.

In some implementations, a scheduling manner of the plurality of terminal devices is a group scheduling manner.

In some implementations, the communications device further includes: a second transmission unit, transmitting first configuration information to the first terminal device among the plurality of terminal devices before the plurality of data flows of the plurality of terminal devices are scheduled based on the multimodal relationship information. The first configuration information is used to indicate one or more of the following: a first identity used for group scheduling; or delay information associated with a first identity.

In some implementations, the first identity is a group identity; or the first identity is an identity of the first terminal device.

In some implementations, the scheduling unit is configured to transmit first DCI to a first terminal device among the plurality of terminal devices. The first DCI is used to schedule a data flow of the first terminal device, and the first DCI is further used to indicate that a data flow of a second terminal device among the plurality of terminal devices is to be transmitted.

In some implementations, the multimodal relationship information includes one or more of the following: a time sequence relationship between downlink data transmitted by a base station to a terminal device; a time sequence relationship between the downlink data submitted by an access layer of a terminal device to an upper layer; a time sequence relationship between uplink data transmitted by a terminal device to a base station; or a time sequence relationship between uplink data submitted by a base station to a network element of the core network.

FIG. 12 is a schematic structural diagram of a communications device according to an embodiment of the present application. The communications device is a core network device, and the communications device 1200 may include a transmission unit 1210.

The transmission unit 1210 is configured to transmit first information to a first base station. The first information includes multimodal relationship information, the multimodal relationship information is used to indicate a multimodal relationship between a plurality of data flows, and the plurality of data flows belong to a plurality of terminal devices.

In some implementations, the multimodal relationship information is used to indicate one or more of the following: a multimodal relationship exists between a first data flow and a second data flow; or a multimodal relationship exists between a first data flow and a third data flow. Both the first data flow and the second data flow belong to a data flow of a terminal device in a cell coverage of the first base station, the terminal device in the cell coverage of the first base station is connected to the first base station, the third data flow belongs to a data flow of a terminal device in a cell coverage of a second base station, and the terminal device in the cell coverage of the second base station is connected to the second base station.

In some implementations, the multimodal relationship information includes one or more of the following: a time sequence relationship between downlink data transmitted by a base station to a terminal device; a time sequence relationship between the downlink data submitted by an access layer of a terminal device to an upper layer; a time sequence relationship between uplink data transmitted by a terminal device to a base station; or a time sequence relationship between uplink data submitted by a base station to a network element of a core network.

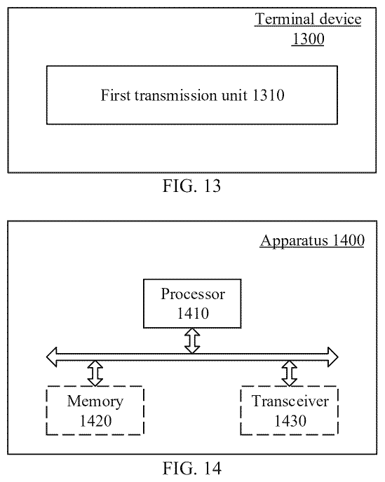

FIG. 13 is a schematic structural diagram of a terminal device according to an embodiment of the present application. The terminal device is a first terminal device, and the terminal device 1300 may include a first transmission unit 1310.

The first transmission unit 1310 is configured to transmit second information to a first base station. The second information includes multimodal relationship information, the multimodal relationship information is used to indicate a multimodal relationship between a plurality of data flows, the plurality of data flows belong to a plurality of terminal devices, and the first terminal device is one of the plurality of terminal devices.

In some implementations, the multimodal relationship information is used to indicate one or more of the following: a multimodal relationship exists between a first data flow and a second data flow; or a multimodal relationship exists between a first data flow and a third data flow. Both the first data flow and the second data flow belong to a data flow of a terminal device in a cell coverage of the first base station, the terminal device in the cell coverage of the first base station is connected to the first base station, the third data flow belongs to a data flow of a terminal device in a cell coverage of a second base station, and the terminal device in the cell coverage of the second base station is connected to the second base station.

In some implementations, the second information is carried in UE assistance information.

In some implementations, the plurality of terminal devices includes a second terminal device, and the second information includes an application layer identity of the second terminal device.

In some implementations, the first terminal device further includes: a first receiving unit, receiving first configuration information transmitted by the first base station. The first configuration information is used to indicate one or more of the following: a first identity used for group scheduling; or delay information associated with a first identity.

In some implementations, the first identity is a group identity; or the first identity is an identity of one of the plurality of terminal devices.

In some implementations, the first terminal device further includes: a second receiving unit, receiving first DCI transmitted by the first base station. The first DCI is used to schedule a data flow of the first terminal device, and the first DCI is further used to indicate that a data flow of a second terminal device among the plurality of terminal devices is to be transmitted.

In some implementations, the first terminal device further includes: a third receiving unit, receiving second DCI transmitted by the first base station, where the second DCI is used to schedule a data flow of the first terminal device; and a fourth receiving unit, receiving the data flow of the first terminal device based on the second DCI.

In some implementations, the multimodal relationship information includes one or more of the following: a time sequence relationship between downlink data transmitted by a base station to a terminal device; a time sequence relationship between the downlink data submitted by an access layer of a terminal device to an upper layer; a time sequence relationship between uplink data transmitted by a terminal device to a base station; or a time sequence relationship between uplink data submitted by a base station to a network element of a core network.

In an optional embodiment, the transmission unit and the receiving unit described above may be a transceiver 1430, and the communications device 1100, the communications device 1200, and the terminal device 1300 may further include a processor 1410 or a memory 1420. Details are shown in FIG. 14.

FIG. 14 is a schematic structural diagram of a communications apparatus according to an embodiment of the present application. Dashed lines in FIG. 14 indicate that a unit or module is optional. The apparatus 1400 may be configured to implement the methods described in the foregoing method embodiments. The apparatus 1400 may be a chip, a terminal device, or a network device.

The apparatus 1400 may include one or more processors 1410. The processor 1410 may support the apparatus 1400 in implementing the method described in the foregoing method embodiments. The processor 1410 may be a general-purpose processor or a dedicated processor. For example, the processor may be a central processing unit (central processing unit, CPU). Alternatively, the processor may be another general-purpose processor, a digital signal processor (digital signal processor, DSP), an application-specific integrated circuit (application specific integrated circuit, ASIC), a field-programmable gate array (field programmable gate array, FPGA) or another programmable logic device, a discrete gate or transistor logic device, a discrete hardware component, or the like. The general-purpose processor may be a microprocessor, or the processor may be any conventional processor or the like.

The apparatus 1400 may further include one or more memories 1420. The memory 1420 stores a program, and the program may be executed by the processor 1410, so that the processor 1410 performs the method described in the foregoing method embodiment. The memory 1420 may be independent of the processor 1410 or may be integrated into the processor 1410.

The apparatus 1400 may further include a transceiver 1430. The processor 1410 may communicate with another device or chip by using the transceiver 1430. For example, the processor 1410 may transmit data to and receive data from another device or chip through the transceiver 1430.

An embodiment of the present application further provides a computer-readable storage medium for storing a program. The computer-readable storage medium may be applied to a terminal or a network device provided in embodiments of the present application, and the program causes a computer to execute a method executed by the terminal device or the network device in embodiments of the present application.

An embodiment of the present application further provides a computer program product. The computer program product includes a program. The computer program product may be applied to the terminal or the network device provided in embodiments of the present application, and the program causes a computer to perform the methods to be performed by the terminal or the network device in various embodiments of the present application.

An embodiment of the present application further provides a computer program. The computer program may be applied to the terminal device or the network device provided in embodiments of the present application, and the computer program causes a computer to execute a method to be executed by the terminal device or the network device in embodiments of the present application.

It should be understood that the terms “system” and “network” in the present application may be used interchangeably. In addition, the terms used in the present application are only used to explain the specific embodiments of the present application, and are not intended to limit the present application. The terms “first”, “second”, “third”, “fourth”, and the like in the specification, claims, and drawings of the present application are used to distinguish between different objects, rather than to describe a specific order. In addition, the terms “include” and “have” and any variations thereof are intended to cover a non-exclusive inclusion.

In the embodiments of the present application, “indicate” mentioned herein may refer to a direct indication, or may refer to an indirect indication, or may mean that there is an association relationship. For example, A indicates B, which may mean that A directly indicates B, for example, B may be obtained by means of A; or may mean that A indirectly indicates B, for example, A indicates C, and B may be obtained by means of C; or may mean that there is an association relationship between A and B.

In embodiments of the present application, “include” mentioned may refer to direct inclusion, or may refer to indirect inclusion. Optionally, the term “include” mentioned in the embodiments of the present application may be replaced with “indicate” or “be used to”. For example, A including B may be replaced with that A indicates B, or A is used to determine B.

In embodiments of the present application, “B corresponding to A” means that B is associated with A, and B may be determined based on A. However, it should be further understood that, determining B based on A does not mean determining B based only on A, but instead, B may be determined based on A and/or other information.

In embodiments of the present application, the term “correspond” may mean that there is a direct or indirect correspondence between the two, or may mean that there is an association relationship between the two, or may mean that there is a relationship such as indicating and being indicated, or configuring and being configured.

In embodiments of the present application, “predefined” or “pre-configured” may be implemented by pre-storing corresponding code, tables, or other forms that may be used to indicate related information in devices (for example, including a terminal device and a network device), and a specific implementation thereof is not limited in the present application. For example, being pre-defined may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution sequences. The execution sequences of the processes should be determined according to functions and internal logic of the processes, and should not be construed as any limitation on the implementation processes of embodiments of the present application.

In several embodiments provided in the present application, it should be understood that, the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented as indirect couplings or communication connections through some interfaces, apparatus or units, and may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected according to actual requirements to achieve the objectives of the solutions of embodiments.

In addition, functional units in embodiments of the present application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (such as a coaxial cable, an optical fiber, and a digital subscriber line (digital subscriber line, DSL)) manner or a wireless (such as infrared, wireless, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (digital video disc, DVD)), a semiconductor medium (for example, a solid state disk (solid state disk, SSD)), or the like.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A wireless communication method, comprising:
obtaining multimodal relationship information, wherein the multimodal relationship information indicates a multimodal relationship between a plurality of data flows, and the plurality of data flows belong to a plurality of terminal devices; and
scheduling the plurality of data flows of the plurality of terminal devices based on the multimodal relationship information.

2. The method according to claim 1, wherein the obtaining multimodal relationship information comprises:
receiving first information transmitted by a first network element of a core network, wherein the first information comprises the multimodal relationship information.

3. The method according to claim 1, wherein the obtaining multimodal relationship information comprises:
receiving second information from a first terminal device, wherein the second information comprises the multimodal relationship information, and the first terminal device is one of the plurality of terminal devices.

4. The method according to claim 1, wherein the multimodal relationship information indicates one or more of following:
a multimodal relationship exists between a first data flow and a second data flow; or
a multimodal relationship exists between a first data flow and a third data flow,
wherein both the first data flow and the second data flow belong to a data flow of a terminal device in a cell coverage of a first base station, the terminal device in the cell coverage of the first base station is connected to the first base station, the third data flow belongs to a data flow of a terminal device in a cell coverage of a second base station, and the terminal device in the cell coverage of the second base station is connected to the second base station.

5. The method according to claim 4, wherein the method further comprises:
transmitting, by the first base station, transmission time information of the first data flow to a second network element of a core network.

6. The method according to claim 4, wherein the method further comprises:
negotiating a scheduling time sequence of data with the second base station.

7. The method according to claim 3, wherein the second information is carried in user equipment (UE) assistance information.

8. The method according to claim 3, wherein the plurality of terminal devices comprise a second terminal device, and the second information comprises an application layer identity of the second terminal device.

9. The method according to claim 1, wherein a scheduling manner of the plurality of terminal devices is a group scheduling manner.

10. The method according to claim 9, wherein before the scheduling the plurality of data flows of the plurality of terminal devices based on the multimodal relationship information, the method further comprises:
transmitting first configuration information to a first terminal device among the plurality of terminal devices, wherein the first configuration information indicates one or more of following:
a first identity used for group scheduling; or
delay information associated with the first identity.

11. The method according to claim 10, wherein the first identity is a group identity; or the first identity is an identity of the first terminal device.

12. The method according to claim 9, wherein the scheduling the plurality of data flows of the plurality of terminal devices based on the multimodal relationship information comprises:
transmitting first downlink control information (DCI) to a first terminal device among the plurality of terminal devices, wherein the first DCI is used to schedule a data flow of the first terminal device, and the first DCI indicates a data flow of a second terminal device among the plurality of terminal devices.

13. The method according to claim 1, wherein the multimodal relationship information comprises one or more of following:
a time sequence relationship between downlink data transmitted by a base station to a terminal device;
a time sequence relationship between downlink data submitted by an access layer of a terminal device to an upper layer;
a time sequence relationship between uplink data transmitted by a terminal device to a base station; or
a time sequence relationship between uplink data submitted by a base station to a network element of a core network.

14. A wireless communication method, comprising:
transmitting first information to a first base station, wherein the first information comprises multimodal relationship information, the multimodal relationship information indicates a multimodal relationship between a plurality of data flows, and the plurality of data flows belong to a plurality of terminal devices.

15. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
obtaining multimodal relationship information, wherein the multimodal relationship information indicates a multimodal relationship between a plurality of data flows, and the plurality of data flows belong to a plurality of terminal devices; and
scheduling the plurality of data flows of the plurality of terminal devices based on the multimodal relationship information.

16. The apparatus according to claim 15, wherein the obtaining multimodal relationship information comprises:
receiving first information transmitted by a first network element of a core network, wherein the first information comprises the multimodal relationship information.

17. The apparatus according to claim 15, wherein the obtaining multimodal relationship information comprises:
receiving second information from a first terminal device, wherein the second information comprises the multimodal relationship information, and the first terminal device is one of the plurality of terminal devices.

18. The apparatus according to claim 15, wherein the multimodal relationship information indicates one or more of following:
a multimodal relationship exists between a first data flow and a second data flow; or
a multimodal relationship exists between a first data flow and a third data flow,
wherein both the first data flow and the second data flow belong to a data flow of a terminal device in a cell coverage of a first base station, the terminal device in the cell coverage of the first base station is connected to the first base station, the third data flow belongs to a data flow of a terminal device in a cell coverage of a second base station, and the terminal device in the cell coverage of the second base station is connected to the second base station.

19. The apparatus according to claim 18, wherein the operations further comprise:
transmitting transmission time information of the first data flow to a second network element of a core network.

20. The apparatus according to claim 18, wherein the operations further comprise:
negotiating a scheduling time sequence of data with the second base station.
